(19) United States
(12) Patent Application Publication
(10) Pub. No.: US 2015/0148531 A1
(43) Pub. Date: May 28, 2015

(54) METHOD FOR THE MANUFACTURE OF CARBONYL DERIVATIVES OF POLYSACCHARIDES

(71) Applicant: TEKNOLOGIAN TUTKIMUSKESKUS VTT, Vitt (FI)

(72) Inventors: Hannu Mikkonen (deceased), (US); Sauli Vuoti, Vtt (FI)

(73) Assignee: TEKNOLOGIAN TUTKIMUSKESKUS VTT, Vtt (FI)

(21) Appl. No.: 14/401,673

(22) PCT Filed: May 15, 2013
(86) PCT No.: PCT/FI2013/050527

§ 371 Date: Nov. 17, 2014

(30) Foreign Application Priority Data
May 15, 2012 (FI) 20125519

(51) Int. Cl. C08B 31/18; C08B 15/04

(52) U.S. Cl. CPC C08B 31/18; C08B 15/04
USPC 536/63; 536/105

(57) ABSTRACT

The invention relates to a method for the manufacture of carbonyl derivatives of polysaccharides and to the oxidization of polysaccharides in the presence of nitrogen dioxide to yield carbonyl derivatives of polysaccharides. The products including carbonyl derivatives of polysaccharides, obtained by the method are also described.

### FIELD OF THE INVENTION

The invention relates to a method for the manufacture of carbonyl derivatives of polysaccharides and to the oxidization of polysaccharides in the presence of nitrogen dioxide to yield carbonyl derivatives of polysaccharides. The invention also relates to products comprising carbonyl derivatives of polysaccharides, obtainable by said method.

### BACKGROUND

Various methods are known in the art for the production of polycarboxylates by oxidative treatment of polysaccharides like starch, cellulose and dextrins. Several oxidizing agents are commonly used for the oxidation of polysaccharides, including oxygen, hydrogen peroxide, sodium chlorite and bromite, periodic acid and periodates, lead(IV) acetate, nitrogen dioxide, dinitrogen teroxide and cerium(IV) salts, as well as 2,2,6,6-tetramethylpiperidine 1-oxyl (TEMPO). Said oxidizing agents react very differently with the anhydroglucose units of polysaccharides. For example, when cellulose is exposed to the action of nitrogen dioxide, oxidation of the primary alcohol group to the carboxyl group is by far the predominant reaction. This oxidizing agent, generally present in equilibrium with dinitrogen tetroxide, may be used in gaseous form or in solution in an inert organic solvent.

Nitrogen dioxide dimerizes readily to an equilibrium mixture with nitrogen tetroxide:

2NO₂<=>N₂O₄

The mixture is a pungent brownish liquid; see Handbook of Biodegradable Polymers, ed. Domb, A. J. et al., (1997) vol 7, p. 294.

A method for oxidizing cellulose with nitrogen dioxide is disclosed in DE 967144. DE 967144 points out some typical problems relating to the oxidation of cellulose, particularly when cellulose is in the form of paper. Water contained in the paper and formed during the reaction is readily converted to nitric acid which penetrates through the paper, causes formation of glue-like material and finally results in the parchmentization of the paper. Particularly, DE 967144 discloses the manufacture of cigarette filters comprising cellulose with high carboxyl content. In the method of DE 967144 creped cellulose paper is formed into rolls having channels in the longitudinal direction. A mixture of nitrogen dioxide and an inert gas (air) is allowed to flow through the rolls whereby carboxyl content of about 10% is achieved. When the oxidation is completed, inert gas or heated steam or a combination thereof is passed through the rolls for the liberation of nitric acid, followed by washing with water. Optionally vacuum may be used.

U.S. Pat. No. 5,541,316 suggests a process for the production of polysaccharide-based polycarboxylic acids or salts thereof, from polysaccharides by oxidation with nitrogen dioxide/dinitrogen tetroxide with at least partial neutralization of the carboxylic acid groups formed, where the oxidation is carried out at a temperature from room temperature to 150° C. in the presence of oxygen, suitably under a pressure of 1 to 10 bar, the oxygen partial pressure being from 0.1 to 9 bar; also air may be used. After the oxidation optionally at least partial neutralization with a basic reagent may be performed. The reaction may be carried out in a suspension, using hydrocarbons and halogenated hydrocarbons (CCl₄) as the suspension medium. Alternatively a dry oxidation process may be used where optionally solid additives may be added for preventing agglomeration and channeling. Oxidized products having carboxyl contents up to 25% may be obtained.

Gas phase oxidation of cellulose is described in Handbook of Biodegradable Polymers, ed. Domb, A. J. et al., (1997) vol 7, p. 295. A roll of surgical gauze plied into 300 layer pads, loaded onto a support frame, was placed in a tubular chamber which was sealed and nitrogen dioxide was admitted to the chamber from an evaporator. The gas was circulated through the layers with a blower at 25° C. for 16-18 h and the reactor was then evacuated and vented. The oxidized gauge was washed with water.

The prior art methods, particularly suitable for the use on an industrial scale, typically utilize expensive reagents and the reuse or recirculation of the used reagents and media is often difficult. In many cases the final product is obtained in salt form requiring further working-up treatments. Also toxic or harmful media, such as carbon tetrachloride is used.

Based on the above it can be seen that there exists a need to provide improved methods for the manufacture of carbonyl derivatives of polysaccharides and particularly to a method for the oxidation of polysaccharides, which methods are also suitable for use on an industrial scale.

### SUMMARY

The present invention is based on studies relating to the oxidation of polysaccharides. The aim of the invention was to provide efficient and economical ways for the production of carbonyl derivatives of polysaccharides. In particular the aim was to provide products comprising carbonyl derivatives of polysaccharides, having desired degrees of substitution, where the degree of polymerization is controlled.

The invention is directed to a method for the manufacture carbonyl derivatives of polysaccharides, said method comprising the steps where:
in the first step nitric acid is allowed to react with elemental copper under gas atmosphere comprising oxygen to yield nitrogen oxide, which is converted to nitrogen dioxide when reacting with oxygen, followed by drying the formed nitrogen dioxide, and
in the second step the dry nitrogen dioxide is allowed to react with at least one polysaccharide to yield carbonyl derivatives of polysaccharides.

In the first step the following reaction is utilized:

Cu(s)+8HNO₃(aq)-->Cu(NO₃)₂(aq)+6NO₂(g)+4H₂O(l)+O₂(g)

In the invention a reaction where fresh nitrogen dioxide is produced, is combined with drying of nitrogen dioxide, followed with a reaction of the fresh and dry nitrogen dioxide with a polysaccharide.

The invention is further directed to a product comprising carbonyl derivatives of polysaccharides, obtainable by the method as described above.

The invention is also directed to the use the products comprising carbonyl derivatives of polysaccharides in applications in the fields of food industry, pharmaceutical industry, pulp and paper industry, techno-chemical industry and the like.

The characteristic features of the invention are presented in the appended claims.

### BRIEF DESCRIPTION OF THE DRAWINGS

FIG. 1 illustrates an embodiment of the method carried out in laboratory scale equipment.

### DEFINITIONS

Unless otherwise specified, the terms, which are used in the specification and claims, have the meanings commonly used in the field of polysaccharide chemistry and industry. Specifically, the following terms have the meanings indicated below.

The term “polysaccharide” is understood here to mean any polysaccharides containing carbohydrate units bearing primary or secondary, or primary and secondary alcohol groups. Examples of such polysaccharides are natural polyglucosans, such as starches (potato starch, wheat starch, cornstarch, tapioca starch etc), celluloses, hemicelluloses (such as xylane, arabinogalactase arabinogalactan, glucomannan, pullulan, dextrin, pectin and tannin etc), polygalactomannans (guaran, carubin, etc.) and the like. The polysaccharides may also be in chemically or physically modified form, providing they contain oxidizable alcohol groups.

The term “carbonyl derivative of polysaccharide” refers here “polycarboxylates” or polysaccharides having primary and/or secondary alcohol groups in the carbohydrate units converted or oxidized to ketones, aldehydes or carboxylic acids. Carboxylic acids refer to carboxylates or carboxyl groups.

The term “degree of substitution”, often referred to as DS, is understood to mean the degree of oxidation of hydroxyl groups, particularly the number of hydroxyl groups modified in each monosaccharide residue in a polysaccharide. Most often DS is an average of the degree of substitution of many monosaccharide residues.

The term “degree of polymerization”, often referred to as DP, is understood to mean the number of monomeric units in a macromolecule or oligomer molecule, block or chain. As applied to cellulose, it refers to the average number of glucose unit in each cellulose molecule of a pulp sample. DP is usually determined by the CED viscosity test.

### DETAILED DESCRIPTION OF THE INVENTION

It was surprisingly found that carbonyl derivatives of polysaccharides may be obtained with an efficient and economic method from polysaccharides, where such method may also suitably used on an industrial scale. The method of the invention is based on the combination of generation of nitrogen monoxide from simple, easily available and low cost starting materials, followed by oxidation of the formed nitrogen monoxide with a gas containing oxygen to yield nitrogen dioxide, which is dried and used as the oxidizing reagent for polysaccharides. When the dry, gaseous and fresh nitrogen dioxide is brought into contact with solid polysaccharide, suitably as powdery or particulate or fibrous material, the hydroxyl groups of the polysaccharide are oxidized to corresponding carbonyl groups. The chemical reactions utilized in the method of the invention are described as follows:

Cu+2HNO₃→2NO+Cu(NO₃)₂

2NO+O₂→2NO₂

NO₂₊polysaccharide→carboxylates/ketones/aldehydes

Particularly, the invention is directed to a method for the manufacture of carbonyl derivatives of polysaccharides, said method comprising the steps where:
in the first step nitric acid is allowed to react with elemental copper (Cu) under gas atmosphere comprising oxygen to yield nitrogen oxide, which is converted to nitrogen dioxide when reacting with oxygen, the formed nitrogen dioxide is conducted through a drying substance to yield dry nitrogen dioxide, and
in the second step the dry nitrogen dioxide is allowed to react with at least one polysaccharide to yield carbonyl derivatives of polysaccharides.

In the first step elemental copper (Cu) is used. Said metal is reacted with nitric acid having a concentration from 60 to 70%, suitably from 65 to 68%. Said reaction is carried out under gas atmosphere comprising oxygen. The gas atmosphere comprising oxygen is selected from air, oxygen atmosphere, combination of oxygen and at least one inert gas, said inert gas being selected from noble gases (helium, argon, neon etc), nitrogen, carbon dioxide and any combinations thereof. In one preferred embodiment of the method according to the invention, oxygen is introduced in the form of air under pressure.

The oxygen content of the gas mixture is suitably 3-100% by volume, preferably at least 4% by volume and more preferably at least 5% by volume. This amount is suitable for providing the gaseous nitrogen oxide whereby also nitrate salt of copper is formed as a crystalline solid, which is easily removable and does not interfere with the reaction. The formed nitrogen oxide is readily converted to nitrogen dioxide (brown heavy gas) in the presence of oxygen.

In the method suitably the mole ratio of nitric acid to copper is approximately 2:1.

The first step is suitably carried out at the temperature from 5 to 35° C., preferably from 18 to 26° C. The pressure is suitably from 0 to 1 bar.

The formed nitrogen dioxide gas is dried using any drying means, suitably with a drying substance. Nitrogen dioxide gas is conducted through a drying substance selected from desiccating agents in anhydrous state and having high affinity for water, generally known in the art. Examples of such drying substances are calcium chloride, calcium sulphate, calcium oxide, barium oxide, magnesium chloride, magnesium sulphate, silica, alumina and sodium sulphate. The desiccating agent is suitably in the form of a porous solid cake. The conducting may suitably be effected using gas flow, preferably gas atmosphere comprising oxygen, suitably oxygen atmosphere or a mixture of oxygen and at least one inert gas. Dry nitrogen dioxide is obtained suitable for the second step.

In the second step the obtained dry nitrogen oxide is allowed to react with at least one polysaccharide or a mixture thereof at a temperature from 0 to 100° C., suitably from 18 to 80° C.

Suitably lower reaction temperatures of 0 to 50° C., preferably 10-40° C. are used if it is desired to maintain DP or limit the decrease of DP and obtain high DS. Lower reaction temperature favors oxidation.

At higher temperature DP is typically decreased. If the maintaining of DP is not necessary, or if it is desirable to decrease it, higher reaction temperatures of 50 to 100° C., preferably 60-80° C. are used. Higher reaction temperatures increase the reaction rate.

The pressure is suitably from 0 to 30 bar, suitably from normal atmospheric pressure to 10 bar. The effect of pressure is similar as that of temperature.

In the case it is desirable to generate aldehyde groups it is preferable to use reaction temperatures from 0 to 30° C. Depending on the chemical structure of the starting materials different products may be obtained. For example hemicelluloses yield typically dialdehydes, celluloses yield more aldehyde groups at low reaction temperatures and carboxylates at higher reaction temperatures, and starches yield carboxylates.

Preferably the polysaccharide is dried before using it as a starting material in the method, suitably to dry matter content of at least 80% by weight.

After the completion of the second step the oxidized polysaccharide product may optionally be washed with water, suitably deionized water for removing any traces of formed HNO₃.

In the oxidation step of the method according to the invention, the oxidizing agent acts directly from the gas phase on the solid, intensively mixed polysaccharide substrates.

The oxidation step of the method may be carried out suitably in reactor comprising a mixing device, such as a blade mixer or any other suitable mixer for solid material. The reactor may comprise an inner vessel comprising pores or openings or the like for allowing any formed nitric acid to be separated to the bottom of the outer vessel. Intensive mixing accelerates the reaction. However, the reaction takes also place to some extent without mixing because of the gaseous reactant.

The method may be carried out as a batch method, semi-batch method or continuous method.

The oxidation step may also be suitably carried out in a fluidized bed of polysaccharide using a gas comprising nitrogen dioxide as the fluidizing agent. A fluidized bed is understood to be the phenomenon observed when gases known as fluidizing agents flow from beneath through a layer of fine-particle material resting on horizontal perforated plates.

Another useful oxidation reactor is an apparatus, in which a gas-based fluidized bed is accommodated in a cylinder in which a shaft equipped with stirring arms is mounted for rotation. It is also possible to use a reactor with a multistage fluidized bed. The reaction may readily be carried out continuously in a reactor of this type.

Suitably the polysaccharide should contain carbohydrate units containing primary and/or secondary alcohol groups, it should be sufficiently dry (dried) and it should be present in a form which enables it to be intensively mixed with the gaseous oxidizing agent and, preferably, to form a fluidized bed, more particularly in powder form.

Suitable polysaccharides are any native polyglucans, more particularly starch and/or cellulose, and other polysaccharides. Since cellulose often presents problems in the development of a fluidized bed on account of its fibrous character, it is suitably used in the form of a micro powder in fluidized beds.

A product comprising carbonyl derivatives of polysaccharides may be obtained, having a DS from 0 to 1.5, suitably from 0 to 1.2. The product may comprise carboxylic acids, ketones, and aldehydes.

The method according to the invention has several advantages. The combination of continuous generation of fresh and dry nitrogen dioxide and the gas-solid oxidation of polysaccharides provides very simple and effective means for the manufacture of carbonyl derivatives of polysaccharides with good yields and quality. No reaction medium is required and thus there are no problems relating to used solvents and there processing. Besides the polysaccharide only simple and cheap nitric acid and elemental copper are needed in the method.

The method can be realized at normal atmospheric pressure and temperature if desired. It was also surprising that the gas-solid reaction can be carried out at moderate reaction temperatures requiring no excess heating. The oxidation reaction of polysaccharides may be accelerated using elevated temperature and pressure.

No toxic or hazardous side products are formed in the method, however because of the toxic nature of the gaseous nitrogen oxides a closed system is highly recommended.

The method is very mild or sensitive when compared with the harsh oxidation methods conventionally used, such as methods based on the use of hydrogen peroxide, TEMPO, etc.

No catalysts are used in the oxidation reaction of polysaccharides.

With the method it is possible to maintain the DP and still achieve a high DS when using lower oxidation reaction temperatures of 0-50°, or alternatively use higher reaction temperatures of 50 to 100° C., when DP decrease is desired, or when the goal to achieve high DS faster and DP decrease is not significant.

The degree of polymerization (DP) of the product can be reduced even down until 10% of the original degree of polymerization as analysed with the CED method using elevated temperatures up to 100° C.

The formation of HNO₃ in the oxidation of polysaccharides can be reduced or even avoided if the gas comprising oxygen contains only oxygen or it is a mixture of oxygen and one or more inert gases, or alternatively the gas is removed from the reaction vessel, for example using vacuum.

The method requires no neutralization step and thus no salt formation takes place.

Cellulose products having the degree of substitution DS1 (C6 hydroxyl group is oxidized) of even 33% may be achieved. Additionally, further substitution can be achieved at secondary hydroxyls.

The method may be used for the oxidation of any polysaccharides containing carbohydrate units bearing alcohol groups. Thus starches, hemicelluloses, celluloses may be oxidized to yield products and intermediates useful in the fields such as food industry, pharmaceutical industry, packaging industry, pulp and paper industry, techno-chemical industry etc.

### EXAMPLES

The following examples are illustrative of embodiments of the present invention, as described above, and they are not meant to limit the invention in any way.

The pressure was normal atmospheric pressure in the examples.

### Example 1

### Manufacture of Carbonyl Derivatives of Potato Starch/RT

100.0 g of potato starch (0.6 moles per anhydroglucose unit) with a moisture content of 4.3% by weight as measured by Karl Fischer titration is weighted to a 1 liter glass reactor. The reactor is fitted with a glass filter (90), which is filled with a drying agent (CaCl₂). 20.0 g of copper wire (99.99%, 2.0 mm diameter) is weighed to another 1 liter glass reactor, and 30.0 mL of nitric acid (65%) is added to the copper under magnetic stirring. A brown gas is formed in the reaction. Air is pumped into the reactor, and the NO₂ gas formed in the reaction is transferred to the reactor containing starch by using air. After the gas has been transferred, the starch is mixed thoroughly for 7 days at room temperature until the brown gas has completely vanished. After 7 days, the reactor was vented and one l of water was added to the mixture. The suspension was then filtered and washed with water until the washing liquid was neutral. The starch was subsequently dried (70° C., vacuum oven). The reaction yielded 94.3 g of white powder-form starch carboxylate with a degree of substitution of 0.17.

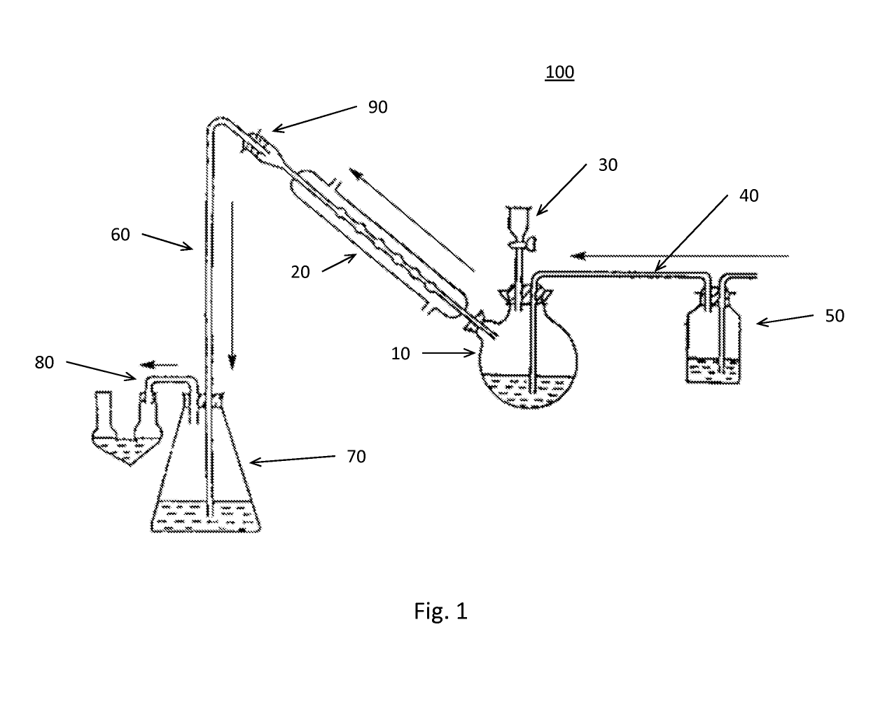

A laboratory scale apparatus (100) used in the example 1 is presented in FIG. 1. The apparatus (100) comprises the reactor (10) comprising copper wire and nitric acid, and it is fitted with a condenser (20), dropping funnel (30) for adding nitric acid, glass pipe (40) for conducting the oxygen comprising gas flow to the reactor (10) from the gas inlet (50), glass filter (90) and reactor (70) comprising polysaccharide, glass pipe (60) for conducting the fresh and dry nitrogen dioxide gas from the filter (20) to reactor (70) into the polysaccharide, glass pipe (80) for removing excess gas from reactor (70) for optional recycling.

The degree of substitution was determined by titration using the traditional saponification method, where the sample (0.5 g) is stirred for 30 minutes in 40 mL of aqueous ethanol (70%), after which 20 mL of 0.5 N NaOH is added to the mixture and stirring continued for 48 h at 50° C. The excess sodium hydroxide is back-titrated with 0.5 N HCl against phenolphthalein as indicator. The degree of substitution was further confirmed by ¹³C-NMR and ¹H-NMR. ¹³C-NMR shows a carboxyl (COOH) content of 0.15 and an aldehyde content (C═OH) of 0.03.

### Example 2

### Manufacture of Carbonyl Derivatives from Potato Starch/50° C.

Example 1 was repeated using 100.0 g of potato starch, which was stirred at 50° C. for 7 days. The reaction yielded 93.6 g of starch carboxylate with a degree of substitution of 0.25. A detailed XPS (x-ray photoelectron spectroscopy) analysis of the sample shows a 5.5% increase of the carboxyl content in the sample.

### Example 3

### Manufacture of Carbonyl Derivatives from Birch Pulp Derived Cellulose/RT

Example 1 was repeated using 100.0 g of birch pulp derived cellulose with a moisture content of 12.9% after drying. The reaction yielded 98.6 g of cellulose carboxylate with a degree of substitution of 0.10.

### Example 4

### Manufacture of Carbonyl Derivatives from Birch Pulp Derived Cellulose/50° C.

Example 1 was repeated using 100.0 g of birch pulp derived cellulose with a moisture content of 11.6% after drying, which was stirred at 50° C. for 3 weeks. The reaction yielded 97.5 g of cellulose carboxylate with a degree of substitution of 0.23. ¹³C-NMR shows a carboxyl (COOH) content of 0.18 and an aldehyde content (C═OH) of 0.05.

### Example 5

### Manufacture of Carbonyl Derivatives from Starch and Cellulose

In the following table 1 results of further examples 5-11 are provided. The method was carried out as described above, however starting materials, reaction times and temperatures were varied.

TABLE 1

| | | Reaction time | Reaction temp. | |
|---|---|---|---|---|
| Example | Polysaccharide | (weeks) | (° C.) | DS |
| 5 | Starch | 2 | 50 | 0.33 |
| 6 | Starch | 3 | 70 | 0.41 |
| 7 | Starch | 4 | 80 | 0.58 |
| 8 | Starch | 5 | 23 | 0.35 |
| 9 | Starch | 7 | 50 | 0.59 |
| 10 | Avicel | 3 | 23 | 0.22 |
| 11 | Birch pulp cellulose | 2 | 50 | 0.25 |

1. A method for the manufacture carbonyl derivatives of polysaccharides, characterized in that said method comprises the steps where:
in the first step nitric acid is allowed to react with elemental copper under gas atmosphere comprising oxygen to yield nitrogen oxide, which is converted to nitrogen dioxide when reacting with oxygen, the formed nitrogen dioxide is dried, and
in the second step the dry nitrogen dioxide is allowed to react with at least one polysaccharide to yield carbonyl derivatives of polysaccharides.

2. The method according to claim 1, characterized in that the gas atmosphere comprising oxygen is selected from air, oxygen atmosphere and combination of oxygen and at least one inert gas.

3. The method according to claim 1, characterized in that the inert gas is selected from noble gases, nitrogen, carbon dioxide and any combinations thereof.

4. The method according to claim 1, characterized in that the oxygen content in the gas atmosphere comprising oxygen is 3-100% by volume.

5. The method according to claim 1, characterized in that the drying of nitrogen dioxide is conducted through a drying substance selected from calcium chloride, calcium sulphate, calcium oxide, barium oxide, magnesium chloride, magnesium sulphate, silica, alumina and sodium sulphate.

6. The method according to claim 1, characterized in that dry nitrogen oxide is allowed to react with at least one polysaccharide or a mixture thereof at a temperature from 0 to 100° C.

7. The method according to claim 1, characterized in that the carbonyl derivatives of polysaccharides are washed with water.

8. The method according to claim 1, characterized in that the polysaccharide is selected from starches.

9. A product comprising carbonyl derivatives of polysaccharides, obtainable by the method according to claim 1.

10. The product according to claim 9, characterized in that it has a degree of substitution of 0-1.5.

11. The product according to claim 9, characterized in that it comprises ketones, aldehydes and carboxylic acids of polysaccharides.

12. The method according to claim 2, wherein the inert gas is selected from noble gases, nitrogen, carbon dioxide and any combinations thereof.

13. The product according to claim 10, characterized in that it comprises ketones, aldehydes and carboxylic acids of polysaccharides.
